(19) United States
(12) Patent Application Publication
(10) Pub. No.: US 2026/0028010 A1
(43) Pub. Date: Jan. 29, 2026

(54) SYSTEM AND METHOD FOR OPERATING A VEHICLE HAVING A HYBRID POWERTRAIN

(71) Applicant: Caterpillar Inc., Peoria, IL (US)

(72) Inventors: Kyle P. HEWERDINE, Chillicothe, IL (US); Sri Vidya Lavanya KAMISETTY, Coppell, TX (US)

(73) Assignee: Caterpillar Inc., Peoria, IL (US)

(21) Appl. No.: 18/784,094

(22) Filed: Jul. 25, 2024

(51) Int. Cl. B60W 10/08

(52) U.S. Cl. CPC B60W 10/08; B60W 2510/205; B60W 2510/244; B60W 2520/10; B60W 2540/10; B60W 2710/083

(57) ABSTRACT

A system and method for operating a hybrid vehicle including hybrid powertrain a controller for controlling the hybrid powertrain. The hybrid powertrain includes a motor-generator unit, a battery electrically connected to a motor-generator unit, an engine, and a transmission engageably connected to the engine and the motor-generator unit. The controller is configured to (1) detect if a triggering event occurs, (2) determine if a boost drive mode is enabled, (3) determine a state of charge of the battery, and (4) determine an amount of excess torque or power available from the motor-generator unit. The controller is configured to signal the motor-generator unit to apply additional motor torque to the hybrid powertrain when (1) the triggering event occurs, (2) the boost drive mode is enabled, (3) a state of charge of the battery is above a threshold, and (4) excess torque or power from the motor-generator unit is available.

### TECHNICAL FIELD

The present disclosure relates generally to hybrid vehicles, and more particularly, to a system and method for operating a vehicle having a hybrid powertrain.

### BACKGROUND

Hybrid vehicles have multiple inputs for supplying power and torque to a powertrain. Commonly, hybrid vehicles have an engine that uses combustible fuel and a motor that uses electricity from a battery to propel the vehicle. The multiple sources of propulsion allow for a greater number of degrees of freedom in controlling the powertrain. These multiple degrees of freedom may allow an engine to run at a specified operating condition, such as maximum torque or power, to increase the efficiency of the engine, while using the motor to supply any additional torque or power needed. The application of additional torque or power by the motor may be referred to as “boost.” Often, however, a user must specifically command that boost be applied.

U.S. Patent Application Publication No. 2023/0331245, published on Oct. 19, 2023 (“the '245 publication”), describes a control method for a boost of a vehicle for increasing a boost mode use time by a driver to maximize the acceleration performance and commercial value of a vehicle. The method includes entering, by a controller, the boost mode so that boost-driving is performed when there is input of boost mode-on by a user. The method further includes obtaining, by the controller, real-time driving state variable information while the vehicle is driven in the boost mode, increasing or decreasing, by the controller, a durable boost time in accordance with the obtained real-time driving state variable information, and displaying, by the controller, the boost standby time which is changed, on a display device of the vehicle. However, the '245 application uses a dedicated boost input to activate boost, and does not activate boost from one or more driving commands, for example, separate from the user input.

Various aspects of the present invention may solve one or more of the problems set forth above and/or other problems in the art. The scope of the current disclosure, however, is defined by the attached claims, and not by the ability to solve any specific problem.

### SUMMARY

In one aspect, the disclosure relates to a hybrid vehicle having a hybrid powertrain and a controller for controlling the hybrid powertrain. The hybrid powertrain may include a motor-generator unit, a battery electrically connected to a motor-generator unit, an engine, and a transmission engageably connected to the engine and the motor-generator unit. The controller may be configured to (1) detect if a triggering event has occurred, (2) determine if a boost drive mode has been enabled, (3) determine a state of charge of the battery, and (4) determine an amount of excess torque or power available from the motor-generator unit. The controller may be configured to signal the motor-generator unit to apply additional motor torque to the hybrid powertrain when (1) the triggering event has occurred, (2) the boost drive mode has been enable, (3) a state of charge of the battery is above a threshold, and (4) excess torque or power from the motor-generator unit is available.

In another aspect, the disclosure relates to a method of applying boost to a vehicle having a hybrid powertrain. The method may include the steps of detecting, by a controller within the hybrid vehicle, a triggering event. The hybrid vehicle of the method may include a hybrid powertrain having a motor-generator unit, a battery electrically connected to a motor-generator unit, an engine, and a transmission engageably connected to the engine and the motor-generator unit, the transmission having a plurality of gears. The method may further include the steps of: determining, by the controller, if a boost has been enabled; determining, by the controller, a state of charge of the battery; determining, by the controller, an amount of excess motor torque or power available from the motor-generator unit; and applying additional motor torque to the powertrain. The additional motor torque may be applied to the power train when: (1) at least one triggering event has occurred, (2) the boost has been enable, (3) the state of charge of the battery is above a specified threshold, and (4) excess motor torque or power from the motor-generator unit is available.

In yet another aspect, the disclosure relates to a hybrid powertrain for a heavy vehicle. The hybrid powertrain may include a motor-generator unit, a battery electrically connected to a motor-generator unit, an engine, a transmission engageably connected to the engine and the motor-generator unit, and a controller. The controller may be configured to (1) detect if a triggering event has occurred, (2) determine if a boost drive mode has been enabled, (3) determine a state of charge of the battery, and (4) determine an amount of excess motor torque available. The controller is also configured to signal the motor-generator unit to apply additional motor torque to the powertrain when (1) the triggering event has occurred, (2) the boost drive mode has been enable, (3) the state of charge of the battery is above a specified threshold, and (4) excess power from the motor-generator unit is available.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a hybrid vehicle, according to aspects of the disclosure.

FIG. 2 is a schematic diagram of a powertrain of the hybrid vehicle of FIG. 1.

FIG. 3 is a schematic diagram of a control system of the hybrid vehicle of FIG. 1.

FIG. 4 provides a flowchart depicting an exemplary method of applying boost to a vehicle having a hybrid powertrain.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

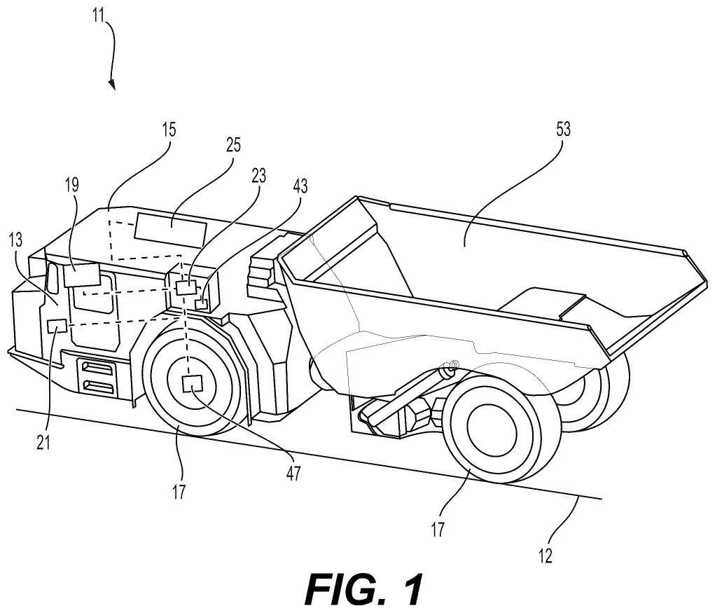

FIG. 1 depicts a hybrid vehicle 11, according to aspects of the disclosure. The hybrid vehicle 11 may include a hybrid powertrain 25, including a motor-generator unit (“MGU”) 27, a battery 29, an engine 31, a flywheel 33, and a transmission 35 having gears 39. The hybrid vehicle 11 may apply boost under a variety of scenarios without a user having to supply a specific boost command separate from the driving inputs.

As shown in FIG. 1, the hybrid vehicle 11 may include a cab 13, a housing 15, and ground engaging elements 17. Within the cab 13, the hybrid vehicle 11 may include a user interface 19 and one or more control elements, for example, pedals 21. The user interface 19 may be a touch screen device, switches, or another appropriate interface(s) for receiving user input. The pedals 21 may include one or more of an accelerator pedal, a brake pedal, or a clutch pedal, depending on the vehicle. Within the housing 15 may be the hybrid powertrain 25, described in more detail below. The hybrid vehicle 11 may further include a controller 23 in electronic communication with the user interface 19, the pedals 21, and the hybrid powertrain 25. The hybrid vehicle 11 may further include an inertial measurement unit (“IMU”) 43 and a wheel speed sensor 47, which may both be mounted on or near one or more ground engaging elements 17 of the hybrid vehicle 11. The IMU 43, the wheel speed sensor 47, and other sensors described below may also be in electronic communication (e.g., via one or more wired or wireless connections) with the controller 23.

FIG. 1 depicts the hybrid vehicle 11 as an articulated haul truck, for example, including a bed 53. Additionally, the ground engaging elements 17 are depicted as tires. In other examples, the hybrid vehicle 11 may be another type of large or heavy vehicle, such as a heavy duty truck, a bus, a track type vehicle, a mining vehicle, etc. Furthermore, in some examples, the ground engaging elements 17 may be another suitable vehicle propulsion system or device, such as one or more tracks (e.g., continuous track treads).

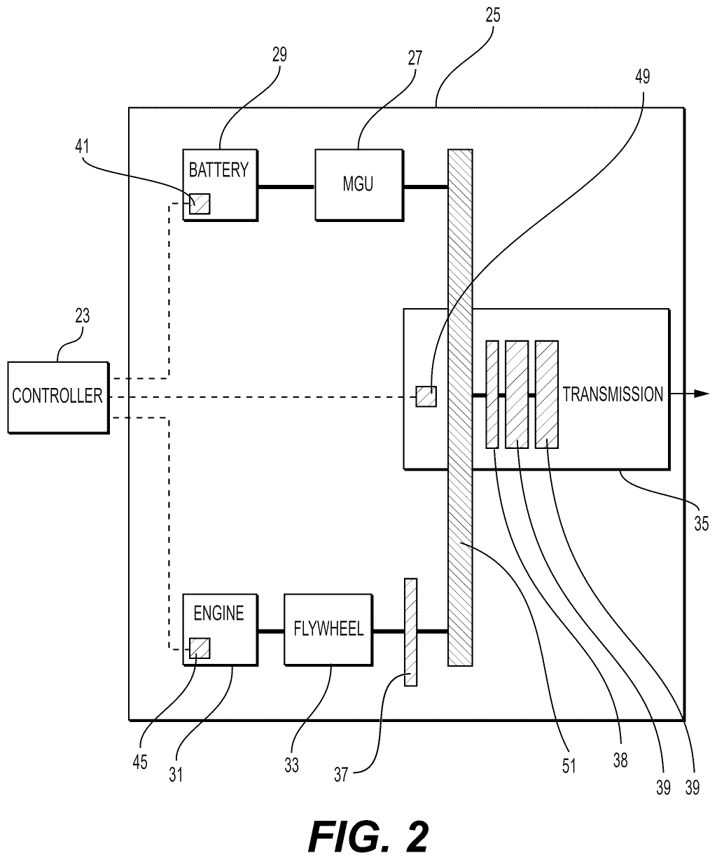

FIG. 2 is a diagram of the hybrid powertrain 25 of the hybrid vehicle of FIG. 1. The battery 29 may be electrically connected to the MGU 27, which may allow power or energy to flow between the battery 29 and the MGU 27, for example, in either direction. The flywheel 33 may be rotatably connected to the engine 31 via a crankshaft (not shown). The flywheel 33 may be engageably and rotatably connected to one or more shaft(s) 51 by a clutch 37. The shaft(s) 51 may extend between the clutch 37 and the MGU 27, and the shaft(s) 51 may connect both the engine 31 and the MGU 27 to the transmission 35.

The transmission 35 may output power received from the MGU 27, the engine 31, or both to the ground engaging elements 17 (FIG. 1). The transmission 35 may include a number of clutches 38 and gears 39. The clutches 37 may interact with the gears 39 so as select and change the gears 39 being driven by the MGU 27 or the engine 31.

The hybrid powertrain 25 may include a number of sensors, which may be in electronic communication (e.g., via wired or wireless connections) with the controller 23. For example, the battery 29 may include a state of charge sensor (“SOC sensor”) 41 connected to the controller 23, and the SOC sensor 41 may relay or otherwise transmit signals indicative of a state of charge of the battery 29 to the controller 23. The engine 31 may include an engine speed sensor 45, and the engine speed sensor 45 may relay or otherwise transmit signals indicative of a speed of the engine to the controller 23. Additionally, the transmission 35 may include a transmission sensor 49, for example, within one or more portions of the transmission 35, and the transmission sensor 49 may relay or otherwise transmit signals indicative of a current selected gear 39 of the transmission 35 to the controller 23. In these aspects, the transmission sensor 49 may monitor or calculate the current selected gear 39 of the transmission 35.

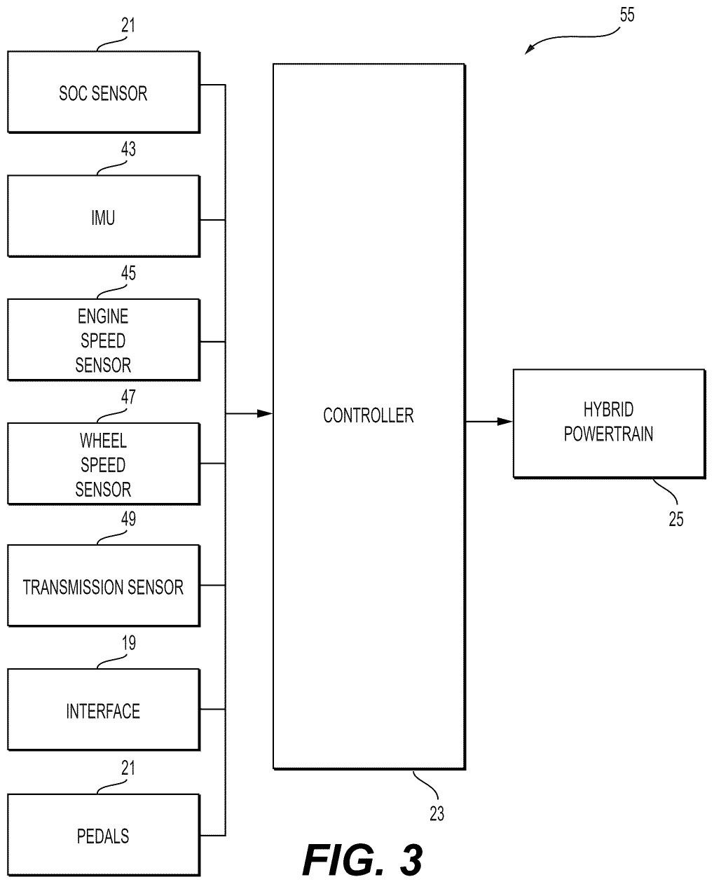

FIG. 3 is a diagram of a control system 55 of the hybrid vehicle of FIG. 1. The control system 55 may include the controller 23, the SOC sensor 41, the transmission sensor 49, the engine speed sensor 36, the wheel speed sensor 47, the IMU 43, the user interface 19, the pedals 21, the hybrid powertrain 25, as well as other sensors and components. As shown in FIG. 3, the controller 23 of the control system 55 may receive one or more inputs from one or more of the SOC sensor 41, the transmission sensor 49, the engine speed sensor 36, the wheel speed sensor 47, the IMU 43, the user interface 19, or the pedals 21. The inputs may include the value or other information measured by the sensors, for example, the state of charge of the battery 29 as measured by the SOC sensor 41, the current gear 39 or speed of the transmission 35 as measured or determined by transmission sensor 49, the speed of the engine 31 as measured by the engine speed sensor 36, the speed of the hybrid vehicle 11 as measured by the wheel speed sensor 47, or the slope or grade of the terrain 12 upon which the hybrid vehicle 11 is operating as measured or determined by the IMU 43. The inputs may also include values input by a user, such as representative values of selections made by a user at the user interface 19, or the value of the amount a user depresses one of the pedals 21. The controller 23 may also send one or more outputs to the transmission 35. The outputs may include, among other things, instructions to the transmission 35 on when to shift gears 39 based on a shift schedule computed or stored by the controller 23.

The controller 23 may be a control module that controls one or more aspects of the hybrid vehicle 11, including for example, the hybrid powertrain 25. The controller 23 may be a single controller configured to control the hybrid vehicle 11. If desired, the controller 23 may be a single controller dedicated to one or more aspects of the hybrid vehicle 11 or combustion engine 200. As used herein the term “controller,” while singular, includes both a single controller and multiple controllers that operate with the hybrid vehicle 11. Thus, the controller 23 may be implemented as a plurality of distributed control modules in communication with each other. The controller 23 may be enabled, via programming, to receive inputs (e.g., from SOC sensor 41) generate outputs (e.g., a gear 39 of the transmission 35).

The controller 23 may embody a single microprocessor or multiple microprocessors that receive inputs or generate outputs. The controller 23 may include a memory, as well as a secondary storage device, a processor, such as a central processing unit, or any other means or devices for accomplishing a task consistent with this disclosure. The memory or secondary storage device associated with the controller 23 may store data and software to allow the controller 23 to perform its functions, including the functions described herein. In particular, the memory for the controller 23 may store instructions that, when executed by one or more processors, enable these processors to perform one or more of the functions described herein. Numerous commercially available microprocessors can be configured to perform the functions of the controller 23. Various other known circuits may be associated with the controller 23, including signal-conditioning circuitry, communication circuitry, and other appropriate circuitry.

During operation, the controller 23 may monitor the inputs to determine if additional motor torque or power (generally referred to as boost) should be applied to the hybrid powertrain 25. The controller may allow boost to be applied only after the occurrence of a triggering event.

### Industrial Applicability

The disclosed aspects of the system and method of operating a vehicle having a hybrid powertrain of the present disclosure may be used to selectively apply boost upon the occurrence of a triggering event.

The application of boost after the occurrence of one or more triggering events allows boost to be applied in different scenarios. The boost does not have to be activated through specific boost commands, but instead be activated by the driving inputs of a user. For example, when the wheel speed slows (as measured by the wheel speed sensor 47), such as when the hybrid vehicle 11 encounters an obstacle such as a slope, mud, or the like, and the engine 31 is at about maximum power, boost can be applied to help the hybrid vehicle 11 overcome an induced load condition caused by the obstacle without specific input from a user. Boost may also be applied by depressing the pedal 21 a specified amount while the hybrid vehicle 11 is at a stop, or depressing the pedal 21 a specified amount while the vehicle is in motion, without requiring a separate boost command. Boost may also be applied after the vehicle reaches a specified trigger speed and a subsequent triggering event occurs.

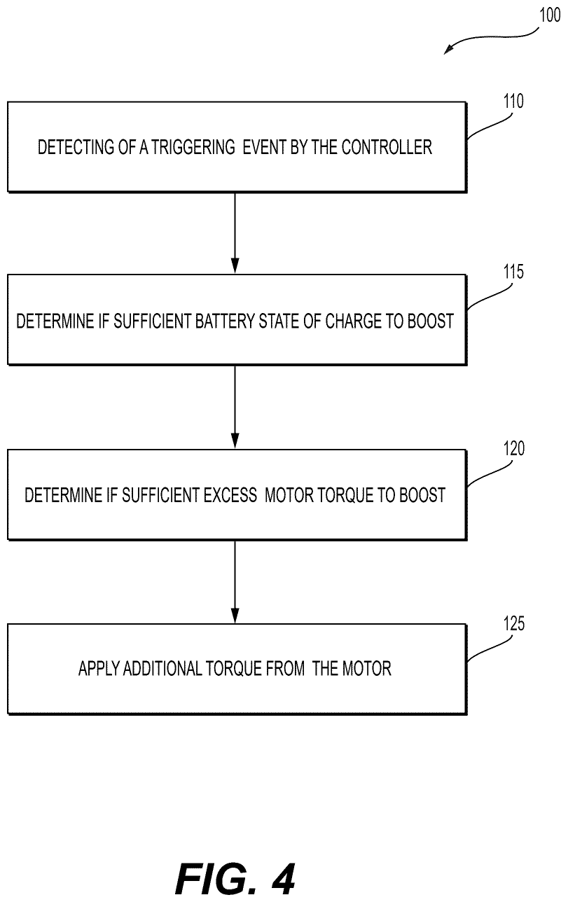

FIG. 4 is flowchart of a method 100 of operating a vehicle having a hybrid powertrain. In a first step 110, the controller 23 may detect one or more triggering events. In some examples, the triggering event may be the wheel speed (e.g., as detected by the wheel speed sensor 47) starting to slow while the engine 31 is within a specified operating range, for example, when the engine 31 is operating above a specified power or speed. For example, the triggering event may be the wheel speed slowing by at least 2 miles per hour (mph) while the engine 31 is operating at 90% or more of its maximum power or speed. In some examples, the triggering event may occur once the engine 31 has maintained operation at or above a specified power or speed for a specified period of time. For example, the triggering event may occur once the wheel speed slows by more than 2 mph after the engine 31 operates at 90% or more of its maximum power for at least 3 seconds.

In other examples, the triggering event may occur when a pedal 21 is depressed beyond a certain amount. For example, the triggering event may occur when an accelerator pedal is depressed to a certain percentage of full engagement, such as 90% or more of full engagement. In such examples, the controller 23 may only recognize the triggering event when the hybrid vehicle 11 is stopped. In such examples, the additional boost may assist the hybrid vehicle 11 accelerate after coming to a full stop.

In further examples, the triggering event may occur when the pedal 21 is depressed more than a specified amount. For example, the triggering event may occur when the pedal 21 is depressed by at least an additional 20%. This may occur while the hybrid vehicle 11 is in motion, and allow a boost to be applied when abrupt changes in acceleration are needed.

In other examples, the triggering events may include the hybrid vehicle 11 reaching a specified speed, and controller 23 may allow boost to be applied once a second triggering occurs.

For example, the controller 23 may allow boost to be applied once (1) the vehicle reaches a convoy speed and then (2) the wheel speed begins to slow.

In yet further examples, the triggering event may occur when the engine 31 is at or near an idle speed, a gear shift occurs, and the speed of the engine 31 drops below a threshold limit. In such examples, the triggering event may occur when the engine 31 is operating at about the engine's 31 idle speed, and the transmission 35 selects a gear 39 after being in neutral (e.g., when no gear is selected in the transmission 35 while the engine 31 is operating), and the speed of the engine 31 drops below a threshold limit. This may occur when the transmission 35 shifts from neutral to a gear 39 that propels the hybrid vehicle 11 in a forward direction or when the transmission 35 shifts from neutral to a gear 39 that propels the hybrid vehicle 11 in a backwards or reverse direction. In such examples, the boost may also be applied when the engine 31 is at about idle speed and the transmission shifts from a gear 39 that propels the hybrid vehicle 11 in a reverse direction to a gear 39 that propels the hybrid vehicle 11 in a forward direction, or vice versa. In such examples, boost may be applied to keep the engine 31 operating in order to prevent a stall.

In other examples, the triggering event may occur when the hybrid vehicle is operating with a gear 39 selected and the speed of the engine 31 is reduced below a threshold value. In such examples, the triggering event may occur when the hybrid vehicle is traversing a terrain 12 that switches from flat to inclined, resulting in the speed of the engine 31 being reduced below a threshold value due to increase load. Once speed of the engine 31 drops below the threshold value, boost may be applied to keep the engine 31 from stalling.

In still further examples, the triggering event may occur when a parasitic load is applied to the engine 31 and communicated to the controller 23. For example, a hydraulic pump (not shown) may be activated within the hybrid vehicle 11 that is powered via the engine 31, which may increase the load on the engine 31. The activation of the hydraulic pump may be communicated to the controller 23. In such examples, boost may be applied to increase the output of the engine 31 and compensate for the parasitic load due to the hydraulic pump.

In some examples, the user may select which triggering events allow for boost from the user interface 19. For example, a user may select all the triggering events described above to allow for the application of boost by the controller 23. In other examples, the user may select a subset of specific triggering events, for example, when the wheel speed decreases while the engine 31 is at maximum power, and when a pedal 21 is depressed more than a specified amount while the hybrid vehicle 11 is stopped. The user may also disable the application of boost from the user interface 19.

Once a triggering event has occurred, then at a step 115, the controller may determine if the state of charge of the battery 29 is sufficient to apply boost. If the battery 29 is at or above a certain threshold state of charge (as measured by the SOC sensor 41), for example, 20%, the controller 23 may allow boost to be applied. If the battery 29 is below a certain threshold state of charge, for example, 20%, then the controller 23 may not allow boost to be applied. The threshold state of charge at which boost is no longer allowed may be programmed into the controller 23, or a user may select the state of charge from, for example, the user interface 19.

If the state of charge of the battery 29 is sufficient to allow boost to occur, then at a step 120, the controller may determine whether the MGU 27 can provide sufficient excess torque of power in order to apply boost, in part by determining the amount of excess torque available from the MGU 27. If the MGU 27 is at or around its maximum power or torque, then the controller 23 may not allow boost to be applied, as the motor may be unable to apply additional power or torque. If the MGU 27 is below its maximum power or torque, then at a step 125, the controller 23 may allow the MGU 27 to apply boost.

It will be apparent to those skilled in the art that various modifications and variations can be made to the disclosed system, vehicle, and method of operating a hybrid vehicle without departing from the scope of the disclosure. Other embodiments of the system, vehicle, and method will be apparent to those skilled in the art from consideration of the specification and practice of the system, vehicle, and method disclosed herein. It is intended that the specification and examples be considered as exemplary only, with a true scope of the disclosure being indicated by the following claims and their equivalents.

What is claimed is:

1. A hybrid vehicle comprising:
a hybrid powertrain including:
a motor-generator unit;
a battery electrically connected to a motor-generator unit;
an engine; and
a transmission engageably connected to the engine and the motor-generator unit, and
a controller for controlling the hybrid powertrain,
wherein the controller is configured to (1) detect if a triggering event has occurred, (2) determine if a boost drive mode has been enabled, (3) determine a state of charge of the battery, and (4) determine an amount of excess torque or power available from the motor-generator unit, and
wherein the controller is configured to signal the motor-generator unit to apply additional motor torque to the hybrid powertrain when (1) the triggering event has occurred, (2) the boost drive mode has been enable, (3) a state of charge of the battery is above a threshold, and (4) excess torque or power from the motor-generator unit is available.

2. The hybrid vehicle of claim 1, wherein the triggering event is a slowing of wheel speed while the engine is within a specified operating range.

3. The hybrid vehicle of claim 1, wherein the triggering event is a slowing of a speed of the engine below a threshold speed of the engine.

4. The hybrid vehicle of claim 1, wherein the hybrid vehicle further includes an accelerator pedal, and wherein the triggering event is a depression of the accelerator pedal beyond a specified depression percentage.

5. The hybrid vehicle of claim 4, wherein the triggering event occurs when the hybrid vehicle is stopped.

6. The hybrid vehicle of claim 4, wherein the triggering event occurs when the hybrid vehicle is in motion.

7. The hybrid vehicle of claim 1, wherein the triggering event is the hybrid vehicle reaching a specified speed, and additional torque or power from the motor-generator unit is applied upon an occurrence of a second triggering event, the second triggering event being a slowing of wheel speed while the engine is within a specified operating range or a depression of an accelerator pedal beyond a specified percentage.

8. A method of applying boost to a vehicle having a hybrid powertrain, the method comprising the steps of:
detecting, by a controller within the hybrid vehicle, a triggering event, the hybrid vehicle comprising a hybrid powertrain including:
a motor-generator unit,
a battery electrically connected to a motor-generator unit,
an engine, and
a transmission engageably connected to the engine and the motor-generator unit, the transmission having a plurality of gears;
determining, by the controller, if a boost has been enabled;
determining, by the controller, a state of charge of the battery;
determining, by the controller, an amount of excess motor torque or power available from the motor-generator unit; and
applying additional motor torque to the powertrain when (1) at least one triggering event has occurred, (2) the boost has been enable, (3) the state of charge of the battery is above a specified threshold, and (4) excess motor torque or power from the motor-generator unit is available.

9. The method of claim 8, wherein the triggering event is a slowing of wheel speed while the engine is within a specified operating range.

10. The method of claim 8, wherein the triggering event is the slowing of a speed of the engine below a threshold speed.

11. The method of claim 8, wherein the triggering event is a depression of a pedal a specified amount.

12. The method of claim 11, wherein the triggering event occurs when the vehicle is stopped.

13. The method of claim 11, wherein the triggering event occurs when the vehicle is in motion.

14. The method of claim 8, wherein the triggering event is the vehicle reaching a specified speed, wherein additional torque or power from the motor-generator unit is applied upon an occurrence of a second triggering event, and wherein the second triggering event is a slowing of wheel speed while the engine is within a specified operating range or a depression of an accelerator pedal beyond a specified amount.

15. A hybrid powertrain for a heavy vehicle, the hybrid powertrain comprising:
a motor-generator unit;
a battery electrically connected to a motor-generator unit;
an engine;
a transmission engageably connected to the engine and the motor-generator unit; and
a controller, wherein the controller is configured to (1) detect if a triggering event has occurred, (2) determine if a boost drive mode has been enabled, (3) determine a state of charge of the battery, and (4) determine an amount of excess motor torque available, and
wherein the controller is configured to signal the motor-generator unit to apply additional motor torque to the powertrain when (1) the triggering event has occurred, (2) the boost drive mode has been enable, (3) the state of charge of the battery is above a specified threshold, and (4) excess power from the motor-generator unit is available.

16. The hybrid powertrain of claim 15, wherein the triggering event is a slowing of wheel speed while the engine is within a specified operating range.

17. The hybrid powertrain of claim 15, wherein the hybrid vehicle further includes an accelerator pedal, and wherein the triggering event is a depression of the accelerator pedal beyond a specified depression percentage.

18. The hybrid powertrain of claim 17, wherein the triggering event occurs when the vehicle is stopped.

19. The hybrid powertrain of claim 17, wherein the triggering event occurs when the vehicle is in motion.

20. The hybrid powertrain of claim 15, wherein the triggering event is the heavy vehicle reaching a specified speed, and additional torque or power from the motor-generator unit is applied upon an occurrence of a second triggering event, the second triggering event being a slowing of wheel speed while the engine is within a specified operating range or a depression of an accelerator pedal beyond a specified percentage.
